(19) United States
(12) Patent Application Publication
(10) Pub. No.: US 2006/0000951 A1
(43) Pub. Date: Jan. 5, 2006

(54) Lift and transport vehicle for the transport of loads in airport areas

(76) Inventors: Roland Hennig, Russelsheim (DE); Dieter Wertheim, Berlin (DE)

Correspondence Address: CHRISTIE, PARKER & HALE, LLP, PO BOX 7068, PASADENA, CA, 91109-7068, US

(21) Appl. No.: 10/516,167

(22) PCT Filed: May 26, 2003
(86) PCT No.: PCT/DE03/01760

§ 371 Date: Jun. 13, 2005

(30) Foreign Application Priority Data
May 29, 2002 (DE) 202 08 510.4
Dec. 10, 2002 (DE) 102 58 474.5

(51) Int. Cl. B64D 9/00

(52) U.S. Cl. 244/137.1; 244/118.1

(57) ABSTRACT

The invention concerns lifting and transport vehicles for transporting loads in the airport sector, with a lifting apparatus mounted on a carrier vehicle and a lifting platform attached to the lifting apparatus for carrying loads, particularly people, freight, containers, deicing appliances and/or catering material, whereby the lifting platform can be lowered and/or raised in at least one lifting range of the lifting apparatus in the direction of travel to the left and/or right beside the carrier vehicle. Furthermore the invention concerns variously designed lifting platforms for such lifting and transport vehicles, particularly with appliances for the transport of goods or aircraft de-icing.

The invention concerns a lifting and transport vehicle for transporting loads in the airport sector according to the pre-characterising portion of Claim 1, and a lifting platform, particularly for such a lifting and transport vehicle, according to the pre-characterising portion of Claim 27.

Many vehicles for loading and unloading aircraft are known. For example, vehicles equipped with a scissor lifting platform are commonly used for transport and to load and unload aircraft with freight, particularly freight containers.

From U.S. Pat. No. 4,176,732 a passenger lift is known, which is suitable in particular for transporting disabled and elderly people. This lift consists of a front stacking truck with a cabin attached, which holds the person being transported and an additional operator.

From U.S. Pat. No. 5,499,694 another passenger lift is known, in which a platform, for example a work platform, is arranged on a lifting apparatus mounted on a chassis. The height of the work platform can be adjusted, without going beyond the limits defined by the travelling gear.

The task of the present invention is to define a mobile apparatus for transporting loads in the airport sector and a flexible transport medium compatible with the apparatus, whereby the drawbacks of the current state of the art can be avoided.

The problem is solved by means of a lifting and transport vehicle for transporting loads in the airport sector having the characteristics of Claim 1. The sub-claims derived therefrom describe advantageous versions of the invention.

According to this claim, a lifting and transport vehicle exhibits a lifting apparatus mounted on a carrier vehicle and a lifting platform attached to the lifting apparatus for carrying loads, particularly people, freight, containers and/or catering material. The lifting platform can be lowered and/or raised in at least one lifting range of the lifting apparatus in the direction of travel to the left and/or right beside the carrier vehicle.

In an advantageous version of the invention, the lifting platform is detachably connected to the lifting apparatus. It is advantageous for the lifting platform to be detachably connected to the lifting apparatus by means of a quick-release lock. This allows easy changing of the different lifting platforms used as transport media. In this way it is possible to use platforms for different applications, particularly for passenger or freight transport or aircraft de-icing, using the same carrier vehicle, thereby reducing costs.

It is advantageous to mount a control device for controlling the carrier vehicle on the lifting platform. The control device can be coupled to the carrier vehicle via a quick-release lock, particularly via a plug connector. Controlling the lifting and transport vehicle by means of the control device mounted on the lifting platform is particularly favourable, since the driver has a complete overview of the vehicle and is always situated at the working height of the lifting platform. This also allows direct contact with the passengers. With combined travelling and lifting operation, the driver has a good overview of the vehicle being controlled and the approaching aircraft or its entrance door. When the lifting platform is changed, the connections of the control device can also be changed quickly.

In a further development of the invention, the carrier vehicle can be operated via a remote control. In this case it is advantageous to couple the remote control to the driving and control apparatus of the carrier vehicle via a quick-release lock, particularly via a plug connector. The carrier vehicle can be operated with the remote control when the lifting platform is detached from the carrier vehicle and therefore a control device mounted on the lifting platform is no longer connected to the carrier vehicle. In this way, different lifting platforms can be attached to the lifting apparatus, it being possible for the carrier vehicle to approach the different platforms under its own power and controlled via the remote control.

In a further advantageous development of the invention, the lifting platform has an essentially closed cabin. Furthermore it is advantageous for the cabin to have a ramp for easy loading of the cabin. Passengers, baggage and/or logistical equipment can be easily and comfortably accommodated in the cabin and safely loaded and unloaded via the ramp.

In a further development of the invention, the lifting platform has devices for holding and/or transporting transport containers, particularly freight containers. It is advantageous for the platform also to have a conveying apparatus, particularly a conveyor belt, for transporting transport containers, particularly freight containers. In this way, using the lifting and transport vehicle according to the invention, freight containers can be transported from any point, such as a freight terminal, and loaded onto an aircraft. It is then possible to load even several freight containers on to the aircraft without difficulty using the conveying apparatus, coupling it to the conveying apparatus normally used on aircraft.

It is advantageous to equip the lifting platform and/or the lifting apparatus with a device for controlling the sideways slope of the lifting platform. It is also advantageous to equip the carrier vehicle and/or the lifting apparatus with a device for controlling the sideways slope of the carrier vehicle. In this way, the lifting platform can be held in a desired position, particularly to keep it absolutely horizontal. This is particularly advantageous when operating with passengers, to offer them maximum comfort and a feeling of security. Compensating for the sideways slope of the carrier vehicle serves to increase stability. Even in the extended position, the lifting and transport vehicle stands and travels safely using the provided control devices, even at high wind speeds and/or under pressure from propeller and/or jet engines of other passing aircraft.

It is advantageous for the carrier vehicle essentially to be a side forklift stacker. It is also advantageous for the lifting apparatus to be operated hydraulically. By using standard components in this way, the lifting and transport vehicle according to the invention can be manufactured at reasonable cost.

It is advantageous for the lifting apparatus also to be movable in a plane of the carrier vehicle essentially perpendicular to the direction of travel. In this way, lifted loads, particularly the lifting platform, can be positioned over the carrier vehicle in a way that satisfies the need for stability.

In a further development of the invention, at least one tank for holding sprayable fluids, particularly a compound mixture and a de-icing agent or cleaning fluid, and at least one spraying device for spraying fluids, particularly de-icing fluid and/or cleaning fluids, is mounted on the lifting platform. In this way the lifting and transport vehicle according to the invention can be used for aircraft de-icing and aircraft cleaning.

When using the invention for aircraft de-icing and aircraft cleaning, it is advantageous to arrange a work platform on the lifting platform to hold at least one person, on which the spraying device is mounted. The work platform can be attached to the lifting platform via a lifting arm, so that the driver can reach the requisite working height from the working platform and carry out the de-icing or cleaning in accordance with regulations.

In a further advantageous development of the invention, a control device for controlling the carrier vehicle and/or the lifting apparatus is mounted on the work platform. In this way the driver is able to operate both the vehicle and the de-icing apparatus. Therefore the whole de-icing process can be carried out efficiently by a single person using this vehicle.

For better protection of the components and/or increased driver comfort, an essentially closed cabin can be provided on the lifting platform and/or the work platform.

In a further design of a lifting and transport vehicle usable for aircraft de-icing, at least one switching device is provided between at least two tanks and the spraying device. This connects the spraying device with the tanks in such a way that only one tank is connected to the spraying device at any one time. Eliminating expensive mixing apparatus and using a simple switching device to switch the fluid feed to the spraying device between the individual tanks significantly reduces the parts and hence the costs of each vehicle.

In an advantageous version of the invention, at least one pumping device for pumping the fluids to be sprayed is mounted between at least one tank and the spraying device. In a further development, at least one tank is provided to hold a de-icing agent and at least one further tank to hold a compound mixture, particularly one consisting of water and a de-icing agent. It is advantageous to provide at least one heating device to heat at least one tank. It is also advantageous for at least one of the tanks to be thermally insulated. These versions make it possible to produce a low-cost set-up for a vehicle with a functional capability similar to conventional spraying vehicles with reduced technical effort. By heating the compound mixture, the vehicle can keep the compound mixture at the desired temperature even with long standing times or short aircraft handling intervals. Thanks to the tank insulation, the compound mixture only needs to be heated in the case of long standing times, thereby saving further on operating costs.

The task of the invention is further performed by a lifting platform with the characteristics of Claim 27. Advantageous versions of the lifting platform are described in the sub-claims derived from this claim.

According to this claim, the lifting platform is detachably connectable to a carrier vehicle. The lifting platform can advantageously be used with one of the lifting and transport vehicles described above.

The lifting platform can have a control device that is used to control a carrier vehicle. The control device can be mounted in a position favourable for the functions of the lifting platform concerned. The lifting platform can have an essentially closed cabin to protect the driver, passengers, goods and/or the technology mounted on the lifting platform. A ramp may be provided on the cabin to facilitate loading of goods or passengers.

If the lifting platform is used to transport goods, it is advantageous to provide the lifting platform with apparatus for holding and/or transporting transport containers, particularly freight containers. For ease of loading and unloading, a conveying apparatus, particularly a conveyor belt, for transporting transport containers, especially freight containers, can be attached to the lifting platform.

In a version of the lifting platform as a de-icing module, at least two tanks for holding sprayable fluids, particularly a compound mixture and a de-icing agent or cleaning fluid, and at least one spraying device for spraying the sprayable fluids is mounted on the lifting platform. To be able to reach the correct working height for de-icing in a flexible manner, a work platform can be arranged on the lifting platform to hold at least one person, on which the spraying device is mounted. The work platform is then advantageously attached to the lifting platform via a lifting arm.

To avoid premature driver fatigue and protect the technology, the lifting platform and/or the work platform can have an essentially closed cabin.

The de-icing system can be set up simply and reliably on the platform using the de-icing module described above. In particular, use of the described system for switching between at least two tanks and the spraying device allows an especially simple set-up.

The essential features of the invention will now be described in further detail on the basis of the examples portrayed in the drawings. These show:

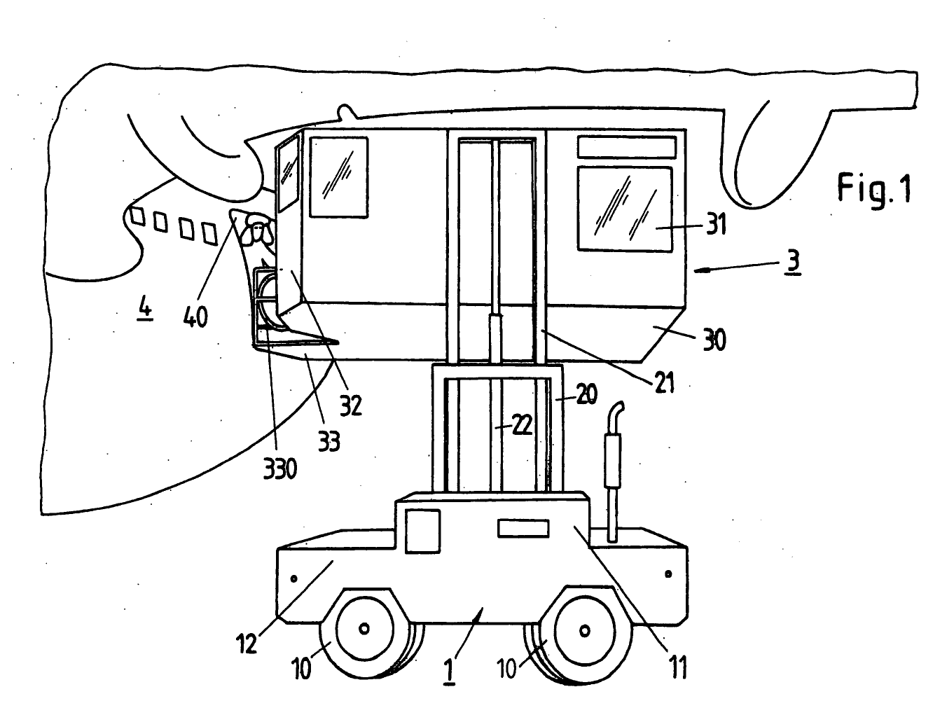

FIG. 1 a perspective view of the lifting and transport vehicle according to the invention in a position with lifting platform extended during the loading and unloading of an aircraft,

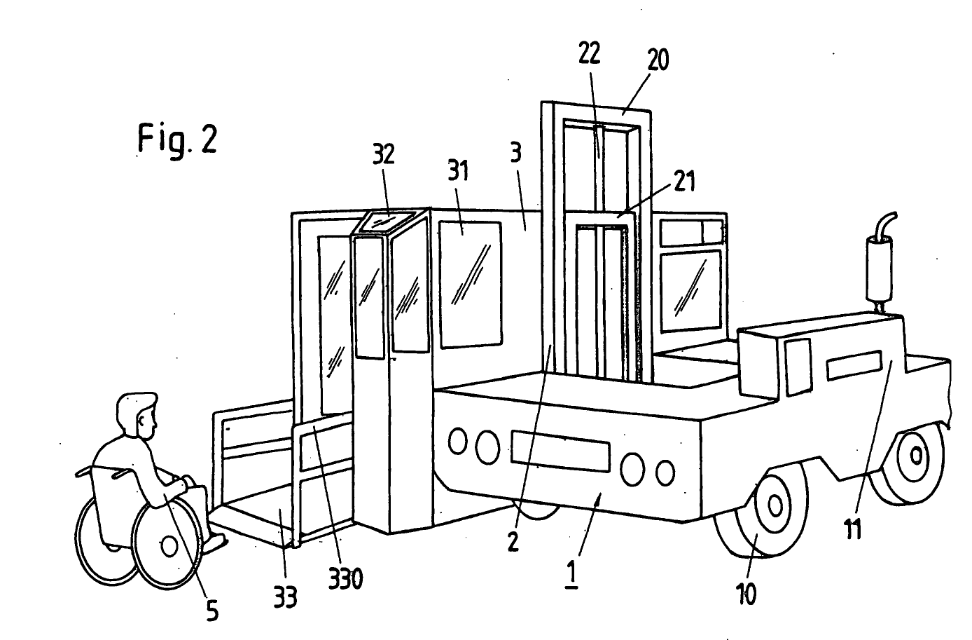

FIG. 2 perspective view of the lifting and transport vehicle from FIG. 1 in a position with the lifting platform lowered beside the carrier vehicle while taking on passengers,

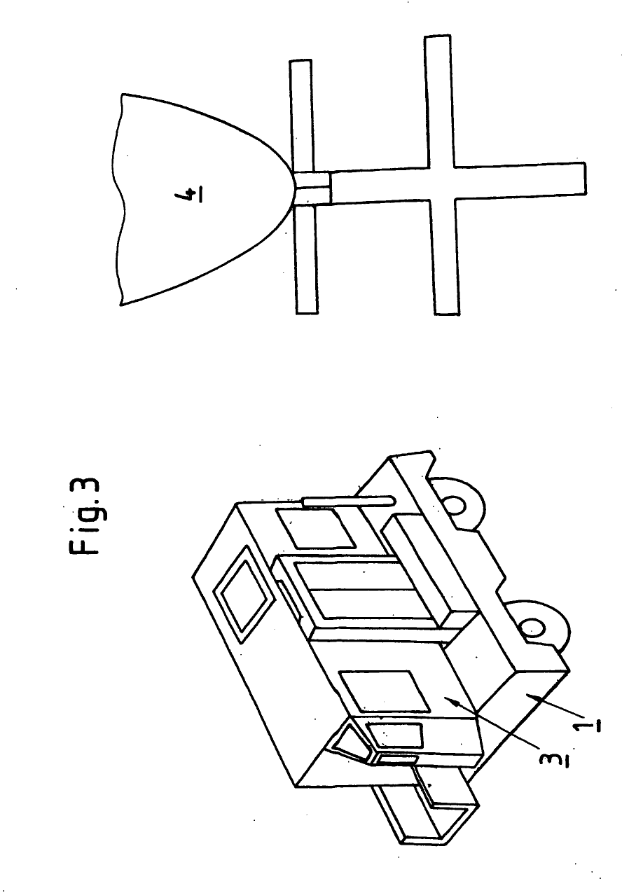

FIG. 3 the lifting and transport vehicle according to the invention of the previous figures in a travelling position,

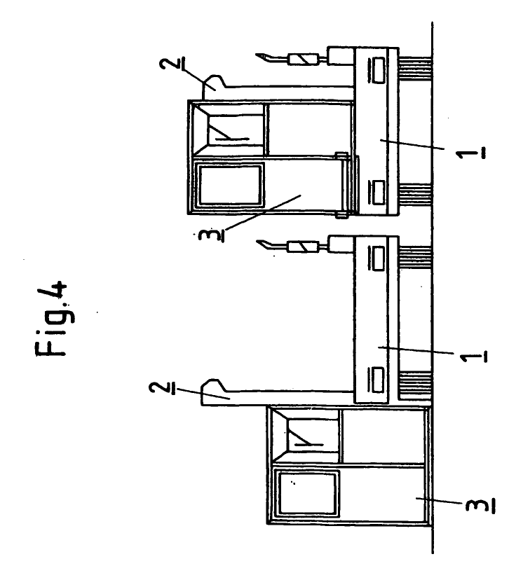

FIG. 4 schematic diagram of the lifting and transport vehicle according to the invention of the previous figures,

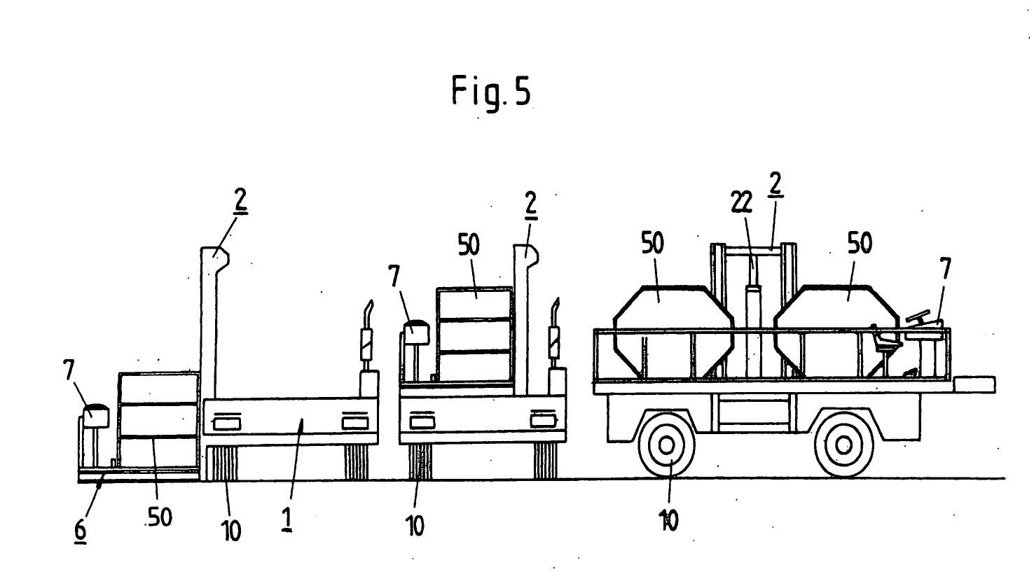

FIG. 5 schematic diagram of a lifting and transport vehicle according to the invention in a further version to accommodate freight containers,

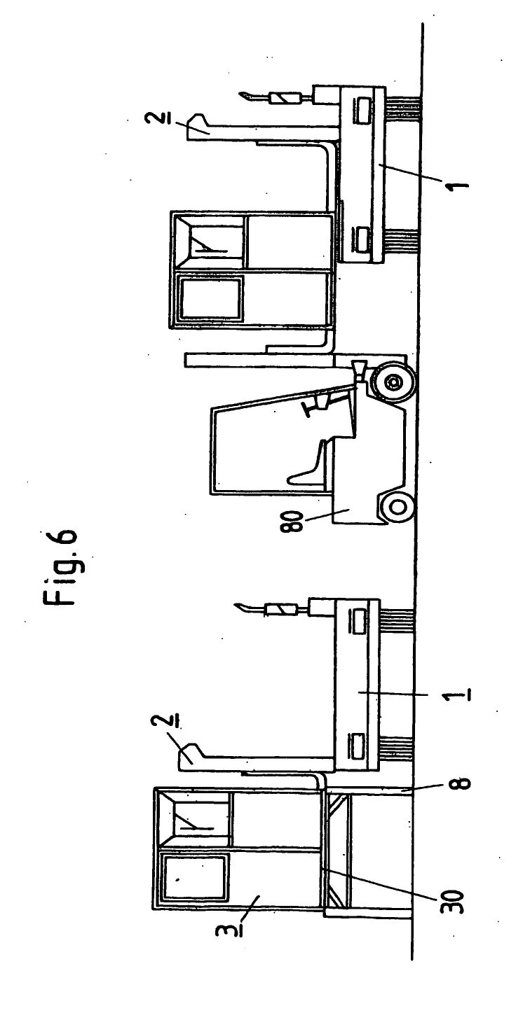

FIG. 6 schematic diagram showing changing of the lifting platform,

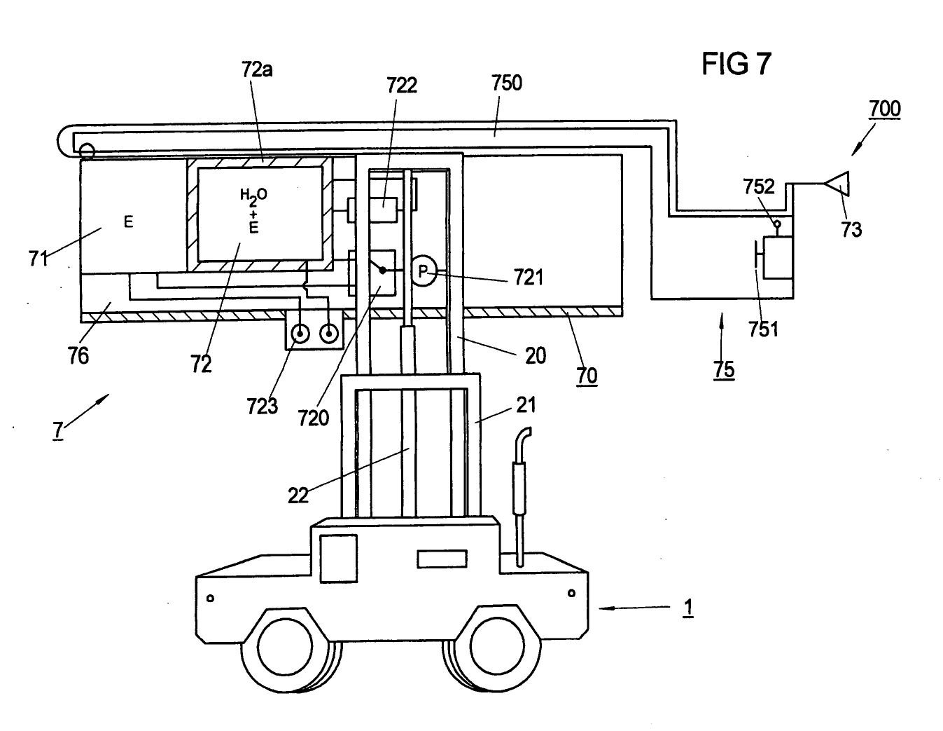

FIG. 7 schematic diagram of a lifting and transport vehicle according to the invention with a spraying device mounted on a lifting platform for applying de-icing agent and other fluids for example to aircraft with the lifting platform in a raised position,

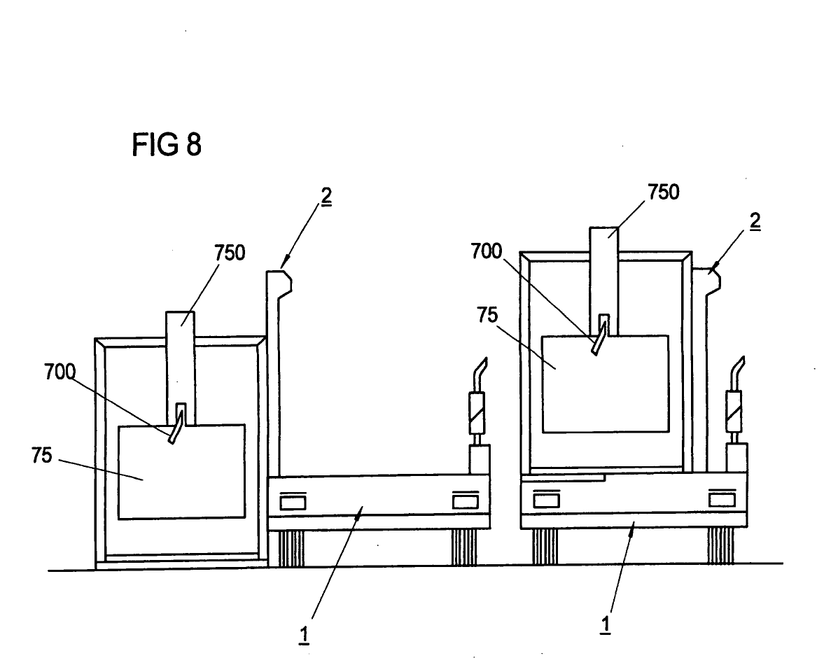

FIG. 8 front view of the lifting and transport vehicle of FIG. 7 in a lowered position and in a travelling position.

FIG. 1 illustrates the lifting and transport vehicle according to the invention for loading and unloading aircraft. The lifting and transport vehicle includes a carrier vehicle 1 equipped with wheels 10 and driven by an engine 11. At least two of the wheels 10 can be steered so that that the carrier vehicle is controllable in the same way as a normal wheeled vehicle.

A lifting apparatus 2 is mounted on the carrier vehicle 1. The lifting apparatus 2 consists of a first lifting frame 20 and a second lifting frame 21, the second lifting frame 21 being guided in the first lifting frame. The lifting apparatus is moved by a hydraulic system 22 and the two lifting frames 20, 21 are moved against each other. The lifting frames 20, 21 can also be extended telescopically and can consist of a large number of elements. The lifting apparatus 2 can be moved perpendicular to the direction of travel and in the plane of the carrier vehicle 1, as clearly illustrated in FIGS. 4, 5 and 6 below. The lifting apparatus 2 can also be moved on the carrier vehicle 1 by a hydraulic drive system. Thanks to this moving capability of the lifting apparatus 2, the loads, particularly the lifting platform, can be ideally positioned over the carrier vehicle, guaranteeing that the carrier vehicle 1 remains highly stable when the load is raised.

The position of the lifting apparatus 2 can also be altered to compensate for wind pressure and/or pressure from the propulsion jets of other passing aircraft acting on the cabin 3 and the lifting apparatus 2 itself. This further improves the stability of the lifting and transport vehicle. Wind pressure can however be compensated through other measures such as, for example, adjusting suspension hardness of a wheel of the carrier vehicle and/or by varying the angle of inclination of the lifting apparatus relative to the vertical. Compensation is carried out by means of a control device that evaluates information from inclination sensors.

A cabin 3 is attached to the second lifting frame 21 of the lifting apparatus 2 by means of a quick-release lock that is not shown here. The cabin 3 serves to hold the loads being lifted, with the floor of the cabin 3 forming the actual lifting platform 30. The cabin 3 is provided with windows 31 and a driver's cabin 32 containing all the controls that a driver needs to drive the carrier vehicle 1 and operate the lifting apparatus 2. For ease of loading and unloading, the cabin 3 is also provided with a ramp 33, over which freight and/or passengers can easily be conveyed into the interior of the cabin 3 and out of it again. The ramp 33 is also used to dock the cabin 3 to an aircraft, particularly in the area of an entrance door 40 of an aircraft 4.

With the apparatus according to the invention in the position shown in FIG. 1, the cabin 3 is raised by means of the lifting apparatus 2 to a height at which passengers can enter an aircraft 4 via the ramp 33 through a door 40. The ramp 33 adjoins the outer skin of the aircraft 4.

FIG. 2 shows the lifting and transport vehicle according to the invention in a position with the cabin 3 set down on the ground by means of the lifting apparatus 2, next to the carrier vehicle 1. In this position a passenger 5, particularly a disabled passenger, can enter the cabin easily via the ramp 33. To facilitate access to the cabin 3 and for safe entry to the aircraft 4, a railing 330 is also attached to the ramp 33. FIG. 2 clearly shows the driver's cabin 32, which is attached to the cabin 3. On the one hand the lifting apparatus 2 and on the other hand the carrier vehicle 1 can be controlled from the driver's cabin 1.

FIG. 3 shows the lifting and transport vehicle according to the invention in a position whereby it is able to cover long distances. The cabin 3 is centrally located on the carrier vehicle 1. The lifting apparatus 2, which in FIG. 2 was located on one side of the carrier vehicle 1, has now been pulled over to the other side of the carrier vehicle 1, by virtue of the fact that the lifting apparatus 2 can be moved perpendicular to the direction of travel. The lifting apparatus 2 can be moved for example hydraulically. In the travelling position shown in FIG. 3, the lifting and transport vehicle is compact and can be steered like a normal wheeled vehicle. The lifting and transport vehicle is set up in this position for transfer, for example between a terminal and an aircraft 4.

FIG. 4 again schematically illustrates the process of lowering the cabin 3 beside the carrier vehicle 1 and picking up the cabin 3. In the left illustration of FIG. 4, the cabin 3 is lowered with the lifting apparatus 2 from the carrier vehicle 1 on to the ground. The cabin 3 is located entirely outside the limits of the carrier vehicle 1 defined by the tyres 10. In this position, the lifting apparatus 2 is located on an external side of the carrier vehicle 1.

In the right illustration of FIG. 4, the cabin 3 is placed on the carrier vehicle 1. The lifting apparatus 2 is moved towards the other side of the carrier vehicle 1, so that the cabin 3 is now entirely inside the limits of the carrier vehicle 1 defined by the tyres 10. The illustrated first position corresponds to a loading position for the cabin 3. The second position corresponds to a travelling position for the lifting and transport vehicle. The cabin 3 can be moved out of this travelling position by the lifting apparatus 2 directly for coupling to an aircraft 4. This is also possible while the carrier vehicle 1 is travelling.

When raised in this position, the cabin 3 is essentially inside the limits of the carrier vehicle 1 defined by the four wheels 10, so the cabin 3 can be raised or lowered without the carrier vehicle 1 requiring additional support. Therefore the carrier vehicle 1 can also be manoeuvred with the cabin 3 in the raised position.

FIG. 5 shows another version of the lifting and transport vehicle according to the invention. This version again shows a carrier vehicle 1 with wheels 10 and a lifting apparatus 2 mounted upon it. This time, the lifting apparatus 2 is connected to a lifting platform 6, on which a control device 7 is mounted. The lifting platform 6 is used to transport freight containers 50. The left illustration of FIG. 5 shows the lifting and transport vehicle in a position whereby the freight containers 50 can easily be loaded on to the lifting platform 6, for example by pushing them on to it.

The lifting platform 6 can be equipped with a conventional conveyor belt, not shown here, so that the freight containers 50 can be conveyed on to the lifting platform 6. The conveyor belt can then be coupled to a conveying apparatus located inside the aircraft.

The central illustration of FIG. 5 shows the lifting and transport vehicle in a travelling position. The containers 50 can easily be transported for example from a freight terminal to an aircraft. On reaching the aircraft, the lifting platform 6 is raised with the lifting apparatus 2 and the containers 50 can be loaded on to the aircraft via the conveying apparatus. Here too, the control device 7 for the carrier vehicle 1 and the lifting apparatus 2 is also mounted on the lifting platform 6. The driver of the lifting and transport vehicle according to the invention always sits at the height of the lifting platform 6 and therefore has an optimum overview of the controlled parts of the vehicle. The right illustration of FIG. 5 shows another view of the lifting and transport vehicle seen from the side.

FIG. 6 schematically illustrates the changing of different lifting platforms 30. Using the lifting apparatus 2, the carrier vehicle 1 can be equipped with different lifting platforms 30, 6 for use in airport operations.

The left illustration of FIG. 6 shows cabin 3 being changed independently. The cabin 3 is set down from the lifting and transport vehicle on stilts 8 and the carrier vehicle 1 is then uncoupled from the cabin 3. To pick up another cabin or another lifting platform, the carrier vehicle 1 is then driven, using a remote control not shown here, to the next cabin or the next lifting platform. It is advantageous to limit the speed of travel in this remote-controlled operating mode, to ensure safe operation of the carrier vehicle 1.

The lifting platform 3, 6 concerned is connected to the lifting apparatus 2 of the carrier vehicle 1 by means of a quick-release lock. This avoids awkward fastening of the cabin 3. The right illustration of FIG. 6 shows the cabin 3 being changed with a forklift truck 80. The cabin 3 is lifted from the carrier vehicle 1 with the forklift truck 80 and can be set down in another place. The lifting platform that replaces it can then be set down on the carrier vehicle 1 with the forklift truck, and connected to the lifting apparatus 2 of the carrier vehicle 1.

FIG. 7 shows a schematic side view of a lifting and transport vehicle 7 according to the invention with an assembly mounted on the lifting platform 70 for applying different fluids to aircraft parts. This assembly is used in particular for de-icing aircraft parts during take-off preparation in winter, but it can also be used for cleaning the outside of aircraft.

The vehicle 7 exhibits the carrier vehicle 1 already described, with the lifting apparatus 2, 20, 21, 22 likewise described. A lifting platform 70 is attached to the lifting apparatus, on which a supply unit enclosed by a cabin 76 is mounted. In the cabin 76 there are two tanks 71, 72 that hold the fluids to be sprayed. The first tank 71 holds pure de-icing agent E, preferably type 11 de-icing agent. The second tank 72 holds a preheated compound mixture consisting of water H₂O and de-icing agent E. The second tank 72, holding the preheated compound mixture, has thermal insulation 72a, which reduces heat loss from the compound mixture stored in the tank 72 and makes further re-heating unnecessary, even if the aircraft 7 is subject to long standing times.

The cabin 76 also contains a switching device 720, whereby it is possible to switch alternately to and fro between the two tanks 71, 72. A pumping device 721 draws fluid through pipes from either one tank 71 or the other tank 72, depending on the position of the switching device 720, and forces it through a pressurised pipe to a spraying device 700 with a spray lance 73.

A work platform 75 is also mounted on the lifting platform 70, on which the spraying device 700 is arranged. The work platform 75 is designed to hold at least one person who, amongst other tasks, operates the spray lance 73 for de-icing the aircraft. On the work platform 75 there is also a control unit 752 with which the switching device 720 can be remotely operated. Furthermore there is a control device 751 with which the person operating the spray lance 73 can also control the work platform 75 and the lifting apparatus 2, 20, 21, 22 of the carrier vehicle 1, as well as the carrier vehicle 1 itself, at least at walking speed.

To de-ice an aircraft, with the lifting platform 70 in the lowered position, the vehicle 7 according to the invention is firstly filled up from a stationary tank installation via an under-floor connection 723, with tank 71 receiving pure de-icing agent and tank 72 a heated compound mixture consisting of water and a de-icing agent. The filled vehicle 7 then travels to the de-icing area at the start of the runway. Here, the aircraft being prepared are first sprayed with the heated compound mixture of water and de-icing agent from tank 72, to remove snow residues and ice deposits from the external surfaces of the aircraft, particularly the wing surfaces. Once the deposits on the aircraft surfaces have been removed, the operator switches to tank 71 containing pure de-icing agent by remotely operating the switching device 720 via the remote control 752. In a second work process, pure de-icing agent is now applied to the outer surfaces of the aircraft in order to prevent further icing of the aircraft until after take-off.

The operator can raise the lifting platform 70 initially to a permissible height over the carrier vehicle 1, and then reach the desired working height by extending the lifting platform 75 on the lifting arm 750.

The simplicity of the de-icing process, which merely involves spraying the outer surfaces of the aircraft and simple switching between the two tanks, prevents operator errors due for example to an incorrect choice of mixing ratio or incorrect preheating. Moreover, the operating personnel merely have to watch the level indicators, not shown here, of the tanks 71, 72. Further observation of weather conditions, temperatures and mixing ratios is unnecessary. As a result, the concentration of the spray lance 73 operator is not broken by other activities.

To make the vehicle 7 according to the invention usable even with prolonged standing times and short aircraft handling intervals, in addition to the insulation 72a of the tank 72 there is also a heating system 722 to correct any drop in the temperature of the de-icing fluid in the tank 72. In a version of the invention not shown here, this heating system is absent, because the insulation 72a and the high heating capacity of the fluid in tank 72 ensure that the temperature drop is sufficiently slow to make reheating unnecessary in normal operation.

FIG. 8 shows the lifting and transport vehicle 7 with the lifting platform 70 in two different positions relative to the carrier vehicle 1. The left illustration shows the lifting platform 70 set down on one side of the carrier vehicle 1. In the right illustration, on the other hand, the supply unit is in a transport position in which the vehicle 7 can be moved for example from a storage tank to its place of use. The possibility of setting down the lifting platform 70 allows easy access to the different components for maintenance or filling.

The invention is not limited to the present example. The essence of the invention is only that a lifting platform of a lifting and transport vehicle can be lowered and/or raised in at least one lifting range of its lifting apparatus in the direction of travel to the left and/or right beside its carrier vehicle for the loading and unloading of aircraft.

1. Lifting and transport vehicle for transporting loads in the airport sector, with a lifting apparatus mounted on a carrier vehicle and a lifting platform attached to the lifting apparatus for carrying loads, particularly people, freight, containers, de-icing appliances and/or catering material, whereby the lifting platform can be lifted over the carrier vehicle in a first lifting range for coupling to an aircraft and, in at least one further lifting range of the lifting apparatus, can be lowered and/or raised in the direction of travel to the left and/or right beside the carrier vehicle,
characterised by the fact
that a control device (7, 751) is mounted on the lifting platform (3, 6, 30, 70) to control the carrier vehicle (1) and the lifting apparatus (2, 20, 21, 22).

2. Lifting and transport vehicle according to claim 1, characterised by the fact that the lifting platform (3, 6, 30, 70) is detachably connected to the lifting apparatus (2, 20, 21, 22).

3. Lifting and transport vehicle according to claim 2, characterised by the fact that the lifting platform (3, 6, 30, 70) is detachably connected to the lifting apparatus (2, 20, 21, 22) by means of a quick-release lock.

4. Lifting and transport vehicle according to claim 1, characterised by the fact that the control device (7, 751) can be coupled to the carrier vehicle (1) via a quick-release lock, particularly via a plug connector.

5. Lifting and transport vehicle according to claim 1, characterised by the fact that the carrier vehicle (1) can be operated via a remote control.

6. Lifting and transport vehicle according to claim 5, characterised by the fact that the remote control can be coupled to the carrier vehicle (1) via a quick-release lock, particularly via a plug connector.

7. Lifting and transport vehicle according to claim 1, characterised by the fact that the lifting platform (30, 70) has an essentially closed cabin (3, 76).

8. Lifting and transport vehicle according to claim 7, characterised by the fact that a ramp (33) is provided on the cabin (3) to facilitate loading of the cabin (3).

9. Lifting and transport vehicle according to claim 1, characterised by the fact that the lifting platform (6) has devices for holding and/or transporting transport containers (50), particularly freight containers.

10. Lifting and transport vehicle according to claim 9, characterised by the fact that the lifting platform (6) has a conveying apparatus, particularly a conveyor belt, for transporting transport containers (50), particularly freight containers.

11. Lifting and transport vehicle according to claim 1, characterised by the fact that the lifting platform (3, 6, 30, 70) and/or the lifting apparatus (2, 20, 21, 22) has a device for controlling the sideways slope of the lifting platform (3, 6, 30, 70).

12. Lifting and transport vehicle according to claim 1, characterised by the fact that the carrier vehicle (1) and/or the lifting apparatus (2, 20, 21, 22) has a device for controlling the sideways slope of the carrier vehicle (1).

13. Lifting and transport vehicle according to claim 1, characterised by the fact that the carrier vehicle (1) is essentially a side forklift stacker.

14. Lifting and transport vehicle according to claim 1, characterised by the fact that the lifting apparatus (2, 20, 21, 22) is hydraulically operated.

15. Lifting and transport vehicle according to claim 1, characterised by the fact that the lifting apparatus (2) can additionally be moved in a plane of the carrier vehicle (1) essentially perpendicular to the direction of travel.

16. Lifting and transport vehicle according to claim 1, characterised by the fact that at least one tank (71, 72) for holding sprayable fluids, particularly a compound mixture and a de-icing agent or cleaning fluid, and at least one spraying device (700) for spraying the sprayable fluids is mounted on the lifting platform (70).

17. Lifting and transport vehicle according to claim 16, characterised by the fact that a work platform (75) is provided on the lifting platform (70) to hold at least one person, the spraying device (700) being mounted on the work platform (75).

18. Lifting and transport vehicle according to claim 17, characterised by the fact that the work platform (75) is attached to the lifting platform (70) via a lifting arm (750).

19. Lifting and transport appliance according to one of claims 16 to 18, characterised by the fact that a control device (751) is provided on the work platform (75) to control the carrier vehicle (1) and/or the lifting apparatus (2, 20, 21, 22), in such a way that a person can control the carrier vehicle (1) from the work platform (75).

20. Lifting and transport vehicle according to claim 16, characterised by the fact that the lifting platform (70) and/or the work platform (75) has an essentially closed cabin (76).

21. Lifting and transport vehicle according to claim 16, characterised by the fact that a switching device (720) is provided between at least two tanks (71, 72) and the spraying device (700), which connects the spraying device (700) with the tanks (71, 72) in such a way that only one tank (71, 72) is connected to the spraying device (700) at any one time.

22. Lifting and transport vehicle according to claim 16, characterised by the fact that at least one pumping device (721) for pumping the fluids to be sprayed (E, E+H2O) is mounted between at least one tank (71, 72) and the spraying device (700).

23. Lifting and transport vehicle according to claim 16, characterised by the fact that at least one tank (71) serves to hold a de-icing agent (E) and at least one further tank (72) to hold a compound mixture (E+H2O), particularly one consisting of water and a de-icing agent.

24. Lifting and transport vehicle according to claim 16, characterised by the fact that at least one heating device (722) is provided to preheat at least one tank (72) and/or the tank contents (H2O+E).

25. Lifting and transport vehicle according to claim 16, characterised by the fact that at least one tank (72) is thermally insulated.

26. Lifting platform, particularly for a lifting and transport vehicle according to claim 1, whereby the lifting platform is detachably connectable to a carrier vehicle, characterised by the fact that a control device (7, 751) for controlling a carrier vehicle (1) is mounted on the lifting platform (3, 6, 30, 70).

27. Lifting platform according to claim 26, characterised by the fact that the lifting platform (30, 70) has an essentially closed cabin (3, 76).

28. Lifting platform according to claim 27, characterised by the fact that a ramp (33) is provided on the cabin (3) to facilitate loading of the cabin (3).

29. Lifting and transport vehicle according to one of claims 26 to 28, characterised by the fact that the lifting platform (6) has devices for holding and/or transporting transport containers (50), particularly freight containers.

30. Lifting platform according to claim 29, characterised by the fact that the lifting platform (6) has a conveying apparatus, particularly a conveyor belt, for transporting transport containers (50), particularly freight containers.

31. Lifting platform according to claim 26, characterised by the fact that at least one tank (71, 72) for holding sprayable fluids, particularly a compound mixture and a de-icing agent or cleaning fluid, and at least one spraying device (700) for spraying the sprayable fluids is mounted on the platform (70).

32. Lifting platform according to claim 31, characterised by the fact that a work platform (75) is provided on the lifting platform (70) to hold at least one person, on which the spraying device (700) is mounted.

33. Lifting platform according to claim 32, characterised by the fact that the work platform (75) is attached to the lifting platform (70) via a lifting arm (750).

34. Lifting platform according to claim 26, characterised by the fact that the lifting platform (70) and/or the work platform (75) has an essentially closed cabin (76).

35. Lifting platform according to claim 31, characterised by the fact that a switching device (720) is provided between at least two tanks (71, 72) and the spraying device (700), which connects the spraying device (700) with the tanks (71, 72) in such a way that only one tank (71, 72) is connected to the spraying device (700) at any one time.

36. Lifting platform according to claim 31, characterised by the fact that at least one pumping device (721) for pumping the fluids to be sprayed (E, E+H2O) is mounted between at least one tank (71, 72) and the spraying device (700).

37. Lifting platform according to claim 31, characterised by the fact that at east one tank (71) serves to hold a de-icing agent (E) and at least one further tank (72) to hold a compound mixture (E+H2O), particularly one consisting of water and a de-icing agent.

38. Lifting platform according to claim 31, characterised by the fact that at least one heating device (722) is provided to preheat at least one tank (72) and/or the tank contents (H2O+E).

39. Lifting platform according to claim 31, characterised by the fact that at least one tank (72) is thermally insulated.
